(19) United States
(12) Patent Application Publication
(10) Pub. No.: US 2025/0392498 A1
(43) Pub. Date: Dec. 25, 2025

(54) AI-BASED DIGITAL PRE-DISTORTION FOR DIGITAL ENVELOPE TRACKING POWER AMPLIFIERS

(71) Applicant: Samsung Electronics Co., Ltd., Suwon-si (KR)

(72) Inventors: Matthew Tonnemacher, Allen, TX (US); Longfei Yin, Plano, TX (US); Masoud Shahshahani, Allen, TX (US); Chance Anthony Tarver, Arlington, TX (US); Gang Xu, Allen, TX (US)

(21) Appl. No.: 19/201,841

(22) Filed: May 7, 2025

Related U.S. Application Data
(60) Provisional application No. 63/663,450, filed on Jun. 24, 2024.

(51) Int. Cl. H04L 25/02; H04L 25/03; H04L 27/00

(52) U.S. Cl. CPC H04L 25/0254; H04L 27/0014; H04L 2025/0377; H04L 2027/0057

(57) ABSTRACT

Methods and systems for NN-based digital pre-distortion for digital envelope tracking power amplifiers. A computer-implemented method includes receiving a measure of a digital envelope at a digital pre-distortion module having a neural network (NN)-based digital pre-distortion structure for digital envelope tracking (DET), receiving a transmit signal at the digital pre-distortion module, inputting the measure of the digital envelope and the transmit signal into the NN-based digital pre-distortion structure to produce a pre-distorted transmit signal, adjusting nonlinearity compensation of a power amplifier based on the measure of the digital envelope, and using the adjusted nonlinearity compensation of the power amplifier to produce an output signal.

### CROSS-REFERENCE TO RELATED APPLICATIONS AND CLAIM OF PRIORITY

The present application claims priority to U.S. Provisional Patent Application No. 63/663,450, filed on Jun. 24, 2024, which is hereby incorporated by reference in its entirety.

### TECHNICAL FIELD

The present disclosure relates generally to wireless communication systems. More specifically, the present disclosure relates to a system and method for AI-based digital pre-distortion for digital envelope tracking power amplifiers.

### BACKGROUND

In 6G extreme-MIMO systems, there are likely to be hundreds of power amplifiers in a single base station. These power amplifiers typically consume the majority of the power budget of the base station. Moreover, their power-added efficiency (PAE), the main performance metric of a power amplifier, is often as low as 20%. The lower PAE is indicative of wasted power that contributes significantly to thermal concerns and increases the operational expenditure costs of a system. Additionally, there is a nonlinear relationship between input and output power; as the input power increases, a fixed gain is not perfectly maintained. Digital pre-distortion (DPD) may compensate for PA nonlinearity, but conventional DPD assumes that the PA nonlinearity is not dynamic and is not powerful enough to accommodate and address the challenges in PA linearization.

Accordingly, there is a need for systems and methods for improved digital pre-distortion for digital envelope tracking systems that overcome these challenges.

### SUMMARY

The present disclosure relates generally to wireless communication systems and, more specifically, the present disclosure relates to a system and method for AI-based digital pre-distortion for digital envelope tracking power amplifiers.

In one embodiment, a computer-implemented method is provided. The computer-implemented method includes receiving a measure of a digital envelope at a digital pre-distortion module having a neural network (NN)-based digital pre-distortion structure for digital envelope tracking (DET), receiving a transmit signal at the digital pre-distortion module, inputting the measure of the digital envelope and the transmit signal into the NN-based digital pre-distortion structure to produce a pre-distorted transmit signal, adjusting nonlinearity compensation of a power amplifier based on the measure of the digital envelope, and using the adjusted nonlinearity compensation of the power amplifier to produce an output signal.

In another embodiment, an electronic device is provided. The electronic device includes a power amplifier, and a processor operably coupled to the power amplifier. The processor is configured to cause the electronic device to receive a measure of a digital envelope at a digital pre-distortion module having a neural network (NN)-based digital pre-distortion structure for digital envelope tracking (DET), receive a transmit signal at the digital pre-distortion module, input the measure of the digital envelope and the transmit signal into the NN-based digital pre-distortion structure to produce a pre-distorted transmit signal, adjust nonlinearity compensation of the power amplifier based on the measure of the digital envelope, and use the adjusted nonlinearity compensation of the power amplifier to produce an output signal.

In yet another embodiment, a non-transitory computer-readable medium is provided. The non-transitory computer-readable medium includes program code, that when executed by at least one processor of an electronic device, causes the electronic device to receive a measure of a digital envelope at a digital pre-distortion module having a neural network (NN)-based digital pre-distortion structure for digital envelope tracking (DET), receive a transmit signal at the digital pre-distortion module, input the measure of the digital envelope and the transmit signal into the NN-based digital pre-distortion structure to produce a pre-distorted transmit signal, adjust nonlinearity compensation of the power amplifier based on the measure of the digital envelope, and use the adjusted nonlinearity compensation of the power amplifier to produce an output signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data may be permanently stored and media where data may be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example signal envelope of a power amplifier;

FIG. 5A illustrates an example NN-based digital pre-distortion system according to embodiments of the present disclosure;

FIG. 5B illustrates an example ILA-based neural network architecture for the NN-based digital pre-distortion system of FIG. 5A according to embodiments of the present disclosure;

FIG. 6 illustrates an example indirect training method for a neural network model of an NN-based digital pre-distortion system according to embodiments of the present disclosure;

FIG. 7 illustrates an example autoencoder training method for a neural network model of an NN-based digital pre-distortion system according to embodiments of the present disclosure;

FIGS. 8A-8C illustrate an example NN-based digital pre-distortion architecture undergoing the autoencoder training method of FIG. 7 according to embodiments of the present disclosure; and

FIG. 9 illustrates an example method of NN-based digital pre-distortion for digital envelope tracking power amplifiers according to embodiments of the present disclosure.

### DETAILED DESCRIPTION

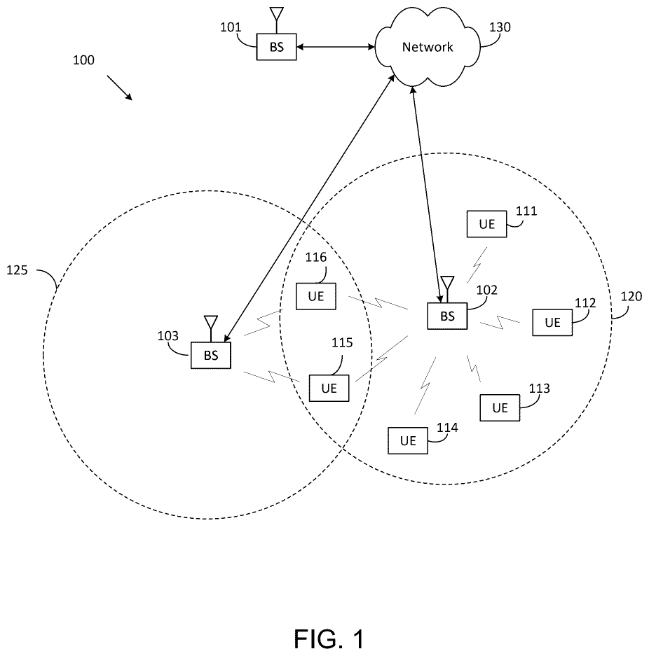

FIG. 1 through FIG. 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, power amplifiers typically consume the majority of the power budget of the base station. While it is convenient to model power amplifiers as having a fixed gain, there is a nonlinear relationship between input and output power. As the input power increases, a fixed gain is not perfectly maintained. Digital pre-distortion (DPD) may be used to compensate for power amplifier nonlinearity by applying a correction to the signal before transmission to account for the nonlinear behavior of a power amplifier.

Additionally, digital envelope tracking (DET) may produce more power-efficient devices by reducing the power consumption of power amplifiers. The reduction in power consumption is accomplished by dynamically modifying the supply voltages amongst multiple discrete voltage levels based on the real-time signal envelope. The lower the amplitude of transmission RF signal is, the lower the power amplifier supply voltage is applied, thus leading lower average operating power of the power amplifier.

However, DET technology can introduce additional challenges to power amplifier linearization due to the time-varying power amplifier characteristics when modifying power amplifier supply voltages dynamically. More specifically, the traditional generalized memory polynomial (GMP) model used for DPD with fixed supply voltage is not flexible enough to manage the time-varying power amplifier characteristics.

Accordingly, the present disclosure provides systems and methods for AI-based digital pre-distortion for digital envelope tracking power amplifiers. As described herein, the present disclosure includes an AI/neural network (NN)-based digital pre-distortion structure that inputs a measure of the digital envelope as a feature to address the challenges in power amplifier nonlinearity compensation when considering DET. In particular, the present disclosure provides AI-based DPD designs where the supply voltage levels are considered as NN inputs along with signal in-phase and quadrature (I/Q) components, such that the NN model is able to determine dynamic nonlinearity when applying different supply voltage levels.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipment (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

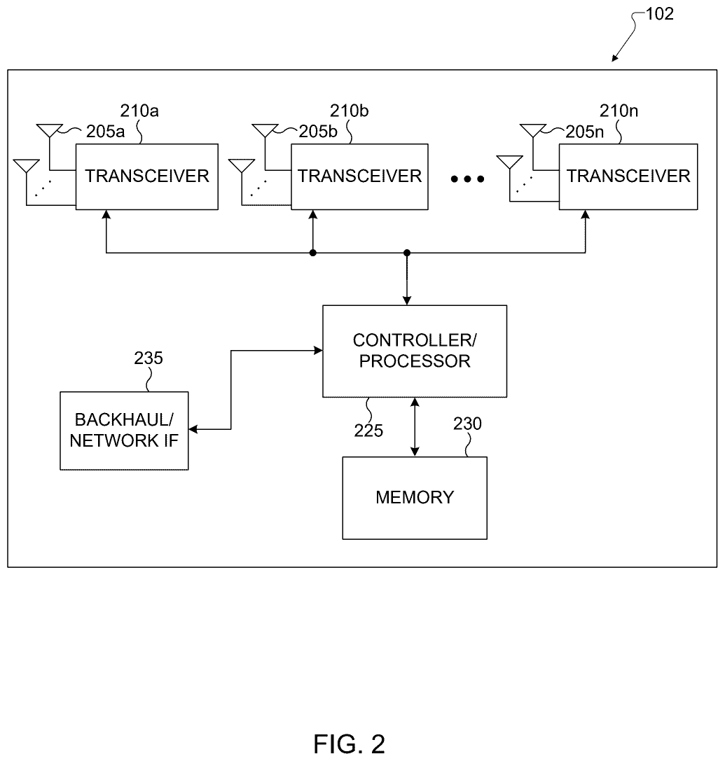

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The network interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the network interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

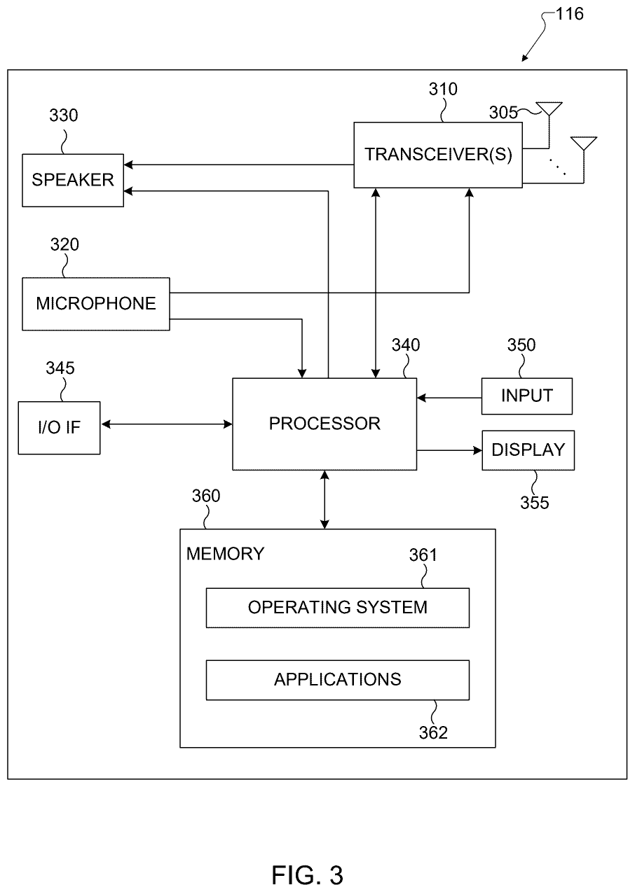

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

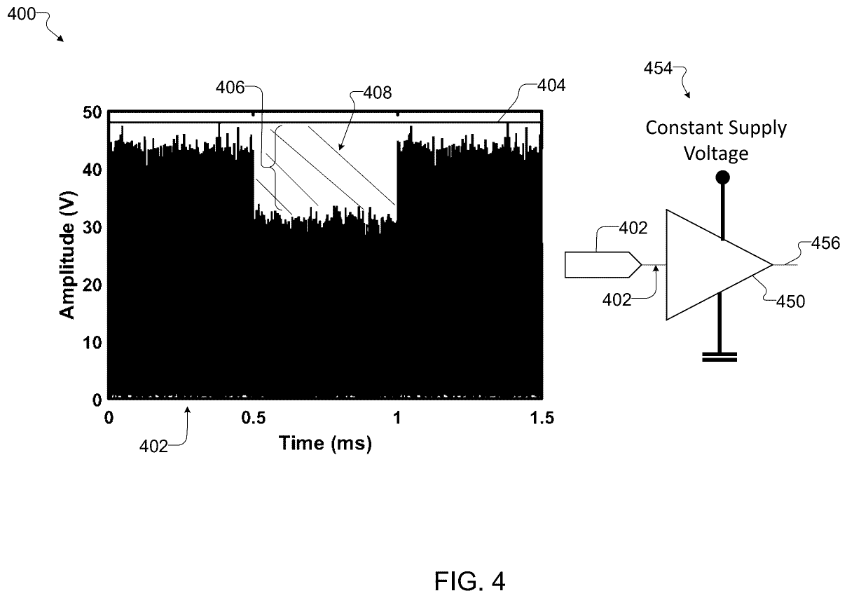

The TX processing circuitry of the gNB 101 may also include one or more power amplifiers coupled to one or more digital-to-analog converters and configured to amplify the baseband signal prior to transmission using the antenna. The one or more power amplifiers receive a supply voltage sufficient to cover the signal envelope of the baseband signal, as shown in FIG. 4.

FIG. 4 illustrates an example signal envelope 400 of a power amplifier 450. As shown in FIG. 4, the signal envelope 400, which may be represented as amplitude voltage over time, includes a RF envelope 402 representative of a baseband signal supplied to the power amplifier 450 from the DAC 452. In response to receiving the RF envelope 402, the power amplifier 450, using a constant supply voltage source 454 provides a PA supply voltage 404 to generate an output signal 456. The PA supply voltage 404 may need to have a voltage level (e.g., 48 volts as shown) greater than the RF envelope 402 to be effective. The RF envelope 402, however, fluctuates over time, creating a gap 406 between the RF envelope 402 and the PA supply voltage 404. The gap 406 creates an area of wasted energy 408 as the PA supply voltage 404 remains constant despite the RF envelope 402 changing voltage levels over time.

Further, the gap 406 forces the power amplifier 450 to operate in a power backoff mode. In a power backoff mode, the power amplifier 450 operates at a reduced power level below its maximum output, especially when dealing with signals that have large peaks in power, ensuring the power amplifier 450 stays within its linear operating region even during high signal bursts from the DAC 452. While operating in backoff mode can improve signal quality, it usually comes at the cost of reduced power efficiency as the power amplifier 450 is not operating at its peak power output. In particular, when the power amplifier 450 operates in a power backoff mode, its power added efficiency (PAE) typically decreases significantly, reducing the effectiveness of the power amplifier 450 in amplifying the RF envelope 402.

Although FIG. 4 illustrates one example of a signal envelope of a power amplifier, various changes may be made to FIG. 4. For example, the baseband signal may fluctuate between more than two voltage levels, such as between three or more voltage levels, such as between 4 or more voltage levels.

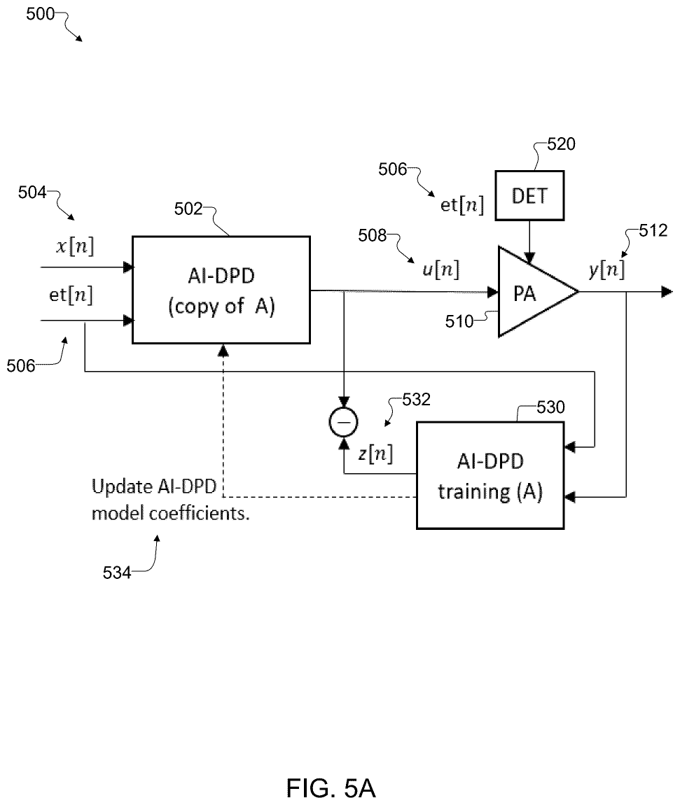

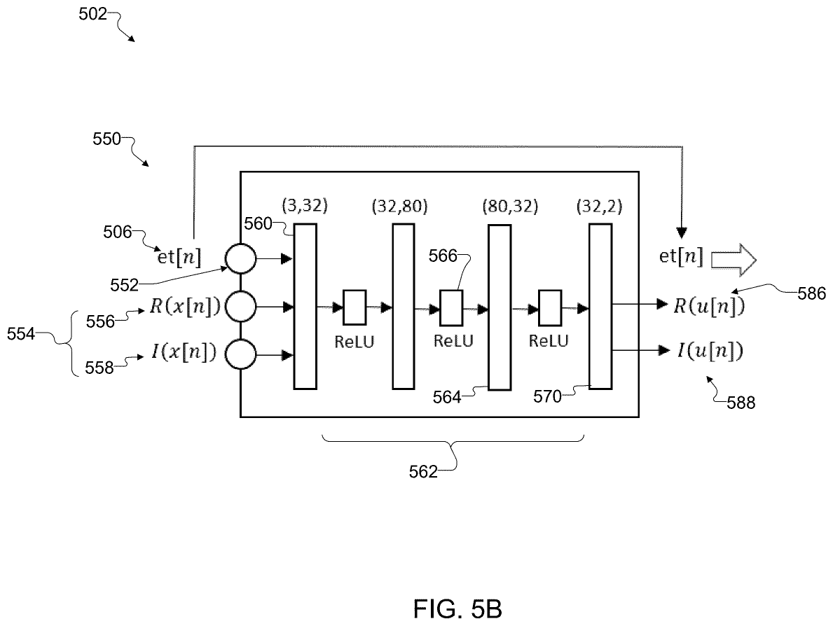

To improve power efficiency, the area of wasted energy 408 should be minimized between the RF envelope 402 and the PA supply voltage 404. This may be accomplished by addressing the challenges in PA nonlinearity compensation when using DET, for example, by providing a pre-distorted RF signal to the PA using an NN-based digital pre-distortion architecture as shown in FIGS. 5A-5B.

FIG. 5A illustrates an example neural network (NN)-based digital pre-distortion (DPD) structure 500 according to embodiments of the present disclosure. The embodiment of the NN-based DPD structure 500 shown in FIG. 5A is for illustration only. Other embodiments of the NN-based DPD structure 500 could be used without departing from the scope of this disclosure.

As shown in FIG. 5A, the NN-based DPD structure 500 may include an AI-DPD model 502 coupled to a power amplifier 510. As shown in FIG. 5A, x[n] is the input discrete transmit signal 504, the measure of the digital envelope, et[n], is the input discrete envelope tracking signal 506, u[n] is the pre-distorted transmit signal 508 (e.g., the pre-distorted version of the input discrete transmit signal 504), y[n] is the power amplifier (PA) output signal 512, and z[n] is the AI-DPD training output estimate 532 of the pre-distorted transmit signal 508.

The AI-DPD model 502, configured to use dynamic nonlinearity, receives the input discrete transmit signal 504 and input discrete envelope tracking signal 506 to produce the pre-distorted transmit signal 508. The input discrete envelope tracking signal 506 may use a neural network to compensate for the non-linearity of the power amplifier 510. For example, the AI-DPD model 502 produces the pre-distorted transmit signal 508 using a neural network, such as a convolutional neural network, with DPD model weights or coefficients. The pre-distorted transmit signal 508 is input into the power amplifier 510, which also receives the input discrete envelope tracking signal 506 from a DET module 520, to produce the output signal 512. The output signal 512 is then input into an AI-DPD training model 530, along with a copy of the input discrete envelope tracking signal 506. The AI-DPD training model 530, which acts as an indirect training module, may then produce a training output estimate 532 based on the output signal 512 and the pre-distorted transmit signal 508. The AI-DPD training model 530 then uses the training output estimate 532 to adjust the DPD model coefficients to produce updated DPD coefficients 534. The AI-DPD model 502 then receives the updated DPD coefficients 534 from the AI-DPD training model 530 and applies the updated DPD coefficients 534 in subsequent operation periods.

In this embodiment, an indirect learning architecture is used to learn and apply the AI-DPD model 502. FIG. 5A shows the NN-based DPD structure 500 using an ILA framework. In the training cycles, the AI-DPD coefficients are updated iteratively. In each iteration, the AI-DPD training model 530 is trained as an inverse of the power amplifier 510 to compensate the nonlinearity based on the measured data, i.e., by using the output signal 512 I/Q components and the corresponding supply voltage levels as NN inputs, and the output signal 512 I/Q components as labels of NN outputs. The trained AI-DPD model coefficients including NN weights and biases are updated in both the AI-DPD training model 530 and the AI-DPD model 502.

By applying the current AI-DPD model 502, the PA measured data including the pre-distorted transmit signal 508, the output signal 512, and the input discrete envelope tracking signal 506 are updated accordingly and will be used to retrain the AI-DPD training model 530 in the next iteration. Importantly, the number of training epochs per cycle are chosen long enough such that the AI-DPD model coefficients completely converge.

FIG. 5B illustrates an example ILA-based neural network architecture 550 for the NN-based DPD structure 500 of FIG. 5A according to embodiments of the present disclosure. The embodiment of the ILA-based neural network architecture 550 shown in FIG. 5B is for illustration only. Other embodiments of the ILA-based neural network architecture 550 could be used without departing from the scope of this disclosure.

As shown in FIG. 5B, the ILA-based neural network architecture 550 of the AI-DPD model 502 may include an envelope tracking signal input neuron 552 and one or more signal I/Q components 554. The envelope tracking signal input neuron 552 receives the input discrete envelope tracking signal 506 and inputs it into the ILA-based neural network architecture 550. The one or more signal I/Q components 554 includes a real transmit signal neuron 556 and an imaginary transmit signal neuron 558 of the input discrete transmit signal 504, where the real transmit signal neuron 556 receives the real portion of the input discrete transmit signal 504 and the imaginary transmit signal neuron 558 receives the imaginary portion of the input discrete transmit signal 504. The AI-DPD model 502 may include an input layer 560, a plurality of hidden layers 562, and an output layer 570. The plurality of hidden layers 562 may include one or more of a convolution layers 564 and one or more rectified linear units or ReLU functions 566. The input layer 560 receives the envelope tracking signal input neuron 552, the real transmit signal neuron 556, and the imaginary transmit signal neuron 558 and passes them to the plurality of hidden layers 562. For example, the input layer 560 may pass the envelope tracking signal input neuron 552, the real transmit signal neuron 556, and the imaginary transmit signal neuron 558 to the ReLU functions 566. The ReLU functions 566 will output the input values (e.g., the envelope tracking signal input neuron 552, the real transmit signal neuron 556, or the imaginary transmit signal neuron 558) if the value is positive and outputs a zero if the input value is negative. The ReLU functions 566, thus, introduces non-linearity into the AI-DPD model 502 as non-linear boundaries and relationships between the input features (e.g., the envelope tracking signal input neuron 552, the real transmit signal neuron 556, and the imaginary transmit signal neuron 558) are represented. The output of the ReLU functions 566 may then be passed to a first convolution layer 564 where features are extracted, using a kernel that slides across the signal (e.g., the envelope tracking signal input neuron 552, the real transmit signal neuron 556, or the imaginary transmit signal neuron 558). The output of the convolution layers 564 may then pass through a subsequent ReLU functions 566 and so on until the processed envelope tracking signal input neuron 552, real transmit signal neuron 556, and imaginary transmit signal neuron 558 reach the output layer 570. The output layer 570 then generates a final result (e.g., a real pre-distorted output signal 586 and an imaginary pre-distorted output signal 588) based on the extracted features from the plurality of hidden layers 562. The real pre-distorted output signal 586 and the imaginary pre-distorted output signal 588 are then passed to the rest of the NN-based DPD structure 500, e.g., the AI-DPD training model 530, and the input discrete envelope tracking signal 506 is passed to the DET module 520.

FIG. 5B shows an example of the ILA-based neural network architecture 550 of the AI-DPD model 502. More advanced neural network architectures may be considered, e.g., by adding a sequence of adjacent DET voltage levels and adjacent signal I/Q components as input neurons or applying recurrent neural networks.

In the ILA-based neural network architecture 550, both in the AI-DPD model 502 and the AI-DPD training model 530 follow the same neural network architecture. An AI-DPD training model 530 is trained and updated together with the AI-DPD model 502 iteratively according to the real-time DET PA characteristics.

Although FIGS. 5A and 5B illustrate an example NN-based digital pre-distortion architecture, various changes may be made to FIGS. 5A and 5B. For example, the ILA-based neural network architecture 550 may be a recurrent neural network or a long-term short memory network.

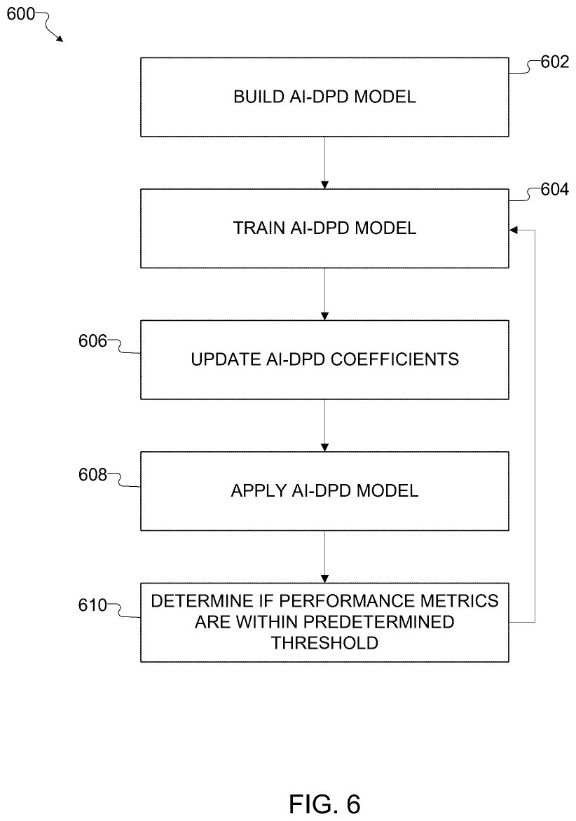

FIG. 6 illustrates an example training method for a neural network model of an NN-based digital pre-distortion system according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of digital pre-distortion could be used without departing from the scope of this disclosure.

An AI-DPD model is built in step 602. For example, the AI-DPD model 502 is built using the ILA-based neural network architecture 550. Alternatively, the AI-DPD model 502 may include other neural networks such as a recurrent neural network or a long-term short memory network. Similarly, the AI-DPD training model 530 may include the same ILA-based neural network architecture 550.

The AI-DPD model is trained to produce AI-DPD coefficients in step 604. For example, the AI-DPD coefficients are updated iteratively. In each iteration, the AI-DPD training model 530 is trained as an inverse of the power amplifier 510 to compensate the nonlinearity based on the measured data, i.e., by using the output signal 512 I/Q components and the corresponding supply voltage levels signal (e.g., the input discrete envelope tracking signal 506) as NN inputs, and the output signal 512 I/Q components as labels of NN outputs.

The AI-DPD coefficients are updated in step 606. For example, the AI-DPD training model 530 may produce a training output estimate 532 based on the output signal 512 and the pre-distorted transmit signal 508. The AI-DPD training model 530 then uses the training output estimate 532 to adjust the DPD model coefficients to produce updated DPD coefficients 534.

The AI-DPD model is applied in step 608. For example, the AI-DPD model 502 may receive the input discrete transmit signal 504 and the input discrete envelope tracking signal 506 and use the ILA-based neural network architecture 550 to produce the pre-distorted transmit signal 508 and provide the pre-distorted transmit signal 508 to the power amplifier 510 during real-time operation of the NN-based DPD structure 500. Further, by applying the current AI-DPD model 502, the PA measured data including the pre-distorted transmit signal 508, the output signal 512, and the input discrete envelope tracking signal 506, is updated accordingly, and will be used to retrain the AI-DPD training model 530 in the next iteration. In other words, training of the NN-based DPD structure 500 using the AI-DPD training model 530 may occur during real-time operation of the NN-based DPD structure 500. This allows the NN-based DPD structure 500 to compensate for real-time non-linearity of the power amplifier 510.

The NN-based DPD structure 500 will also determine if performance metrics are within predetermined threshold in step 610. For example, the NN-based DPD structure 500 may not continuously be updating DPD model coefficients. Providing the updated DPD coefficients 534 to the AI-DPD model 502 may occur periodically or when performance metrics (e.g., power efficiency) are not within a predetermined threshold. If the NN-based DPD structure 500 determines that the performance metrics are not within the predetermined threshold, the AI-DPD training model 530 may operate to generate the updated DPD coefficients 534.

As shown in FIG. 6, multiple cycles of AI-DPD training may be required until the PA output achieves desired adjacent channel leakage ratio (ACLR) and error vector magnitude (EVM) performance. The AI-DPD testing and performance evaluation is performed by fixing the trained AI-DPD model and measuring its performance metrics, e.g., ACLR, EVM, at the output of the power amplifier.

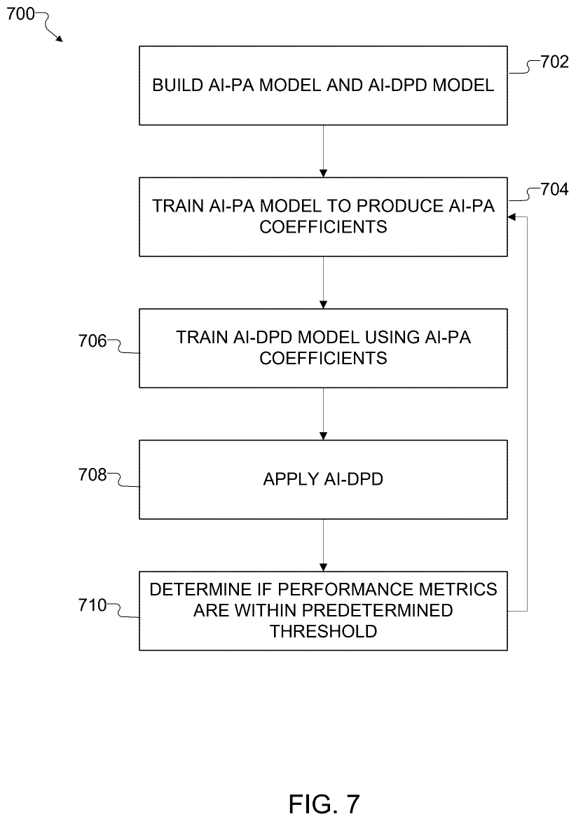

Although FIG. 6 illustrates one example indirect training method 600 for a neural network model of an NN-based digital pre-distortion architecture, various changes may be made to FIG. 6. For example, while shown as a series of steps, various steps in FIG. 6 could overlap, occur in parallel, occur in a different order, or occur any number of times. For example, the NN-based DPD structure 500 may continuously repeat steps 604 through 610. Additionally, the neural network model may be trained using an autoencoder training method, as shown in FIG. 7.

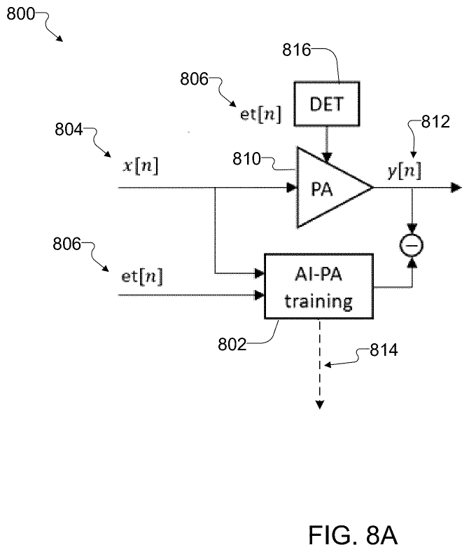

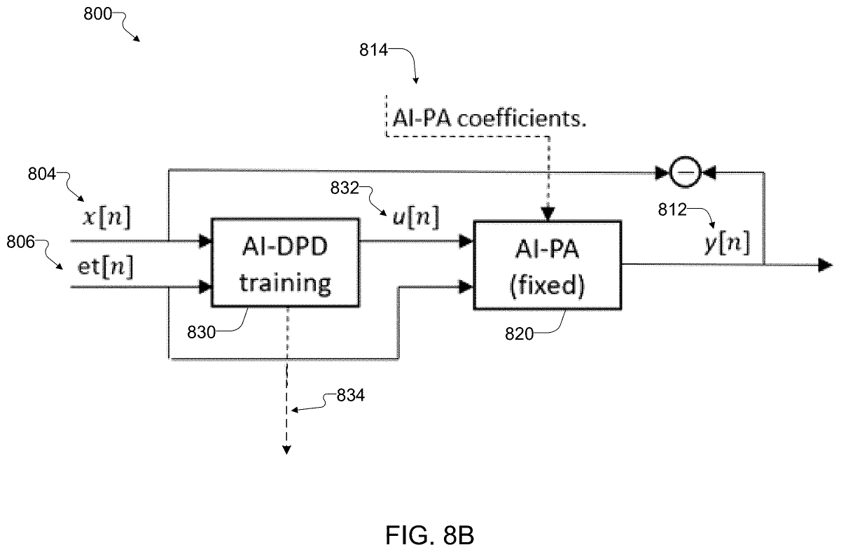

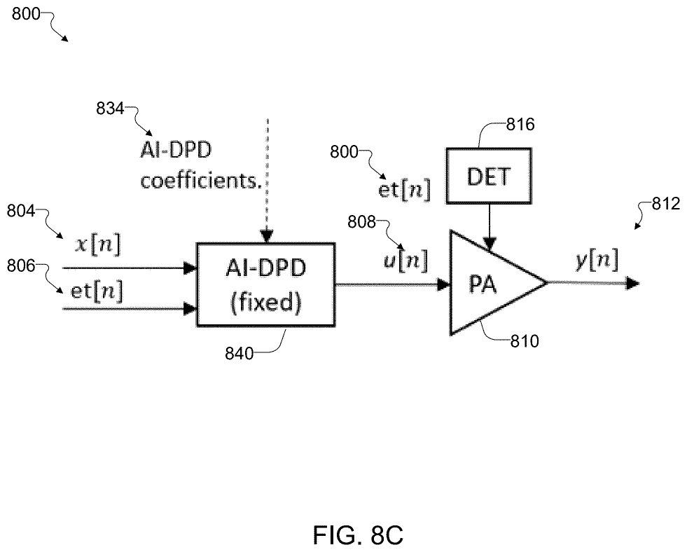

FIG. 7 illustrates an example autoencoder training method for a neural network model of an NN-based digital pre-distortion system according to embodiments of the present disclosure. FIGS. 8A-8C illustrate an example NN-based digital pre-distortion architecture undergoing the autoencoder training method 700 of FIG. 7 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of digital pre-distortion could be used without departing from the scope of this disclosure.

As shown in FIG. 8A, an AI-PA model and AI-DPD model are built in step 702. For example, the NN-based DPD structure 800 may include an AI-PA training model 802 and an AI-PA model 820 that each receive the input discrete transmit signal 804 and the input discrete envelope tracking signal 806. The AI-PA training model 802 and the AI-PA model 820 may include a neural network architecture similar to the ILA-based neural network architecture 550 of FIG. 5B. Similarly, the NN-based DPD structure 800 may include an AI-DPD training module 830 and an AI-DPD model 840 that each receive the input discrete transmit signal 804 and the input discrete envelope tracking signal 806. The AI-DPD training module 830 and the AI-DPD model 840 may include a neural network architecture similar to the ILA-based neural network architecture 550 of FIG. 5B. Alternatively, the AI-PA training model 802, the AI-PA model 820, the AI-DPD training module 830, or the AI-DPD model 840 may include other neural networks, such as recurrent neural networks or long short-term memory networks.

The AI-PA model is trained to produce AI-PA coefficients in step 704. For example, the AI-PA training model 802 is at first obtained and is subsequently integrated as a fixed block during the AI-DPD training model 530 training. When the AI-PA training model 802 is trained, the AI-DPD training module 830 uses the same neural network architecture as the AI-DPD training model 530 in the ILA-based architecture. The only difference during the model training is that the AI-DPD training model 530 in the ILA-based architecture is trained as an inverse of the power amplifier to compensate the non-linearity based on the measured data, while the AI-PA training model 802 is trained forward based on the measured data by using power amplifier input I/Q components and the corresponding supply voltage levels (e.g., the input discrete envelope tracking signal 506) as model inputs, and power amplifier output I/Q components as labels of model outputs. At the completion of training, the AI-PA coefficients 814 used by the AI-PA training model 802 are passed to a fixed AI-PA model 820.

As shown in FIG. 8B, the AI-DPD model is trained using the AI-PA coefficients in step 706. For example, the AI-PA model 820 is fixed, meaning the AI-PA coefficients 814 do not change, while training the AI-DPD training module 830 using AI-DPD coefficients 834 via backpropagation through the AI-PA model 820, which follows an autoencoder structure. The mean squared error (MSE) of the time domain signals at the AI-DPD training module 830 input and the AI-PA model 820 output is used as a loss function. When the MSE is within desired limits, the AI-DPD coefficients 834 are then passed to an AI-DPD model 840 that has the same neural network architecture.

As shown in FIG. 8C, the AI-DPD is applied to a power amplifier in step 708. For example, after obtaining the AI-DPD model 840, it is applied during real-time operation of the NN-based DPD structure 800, including the power amplifier 810 and the DET module 816, to update the measured data, such as the pre-distorted transmit signal 808, the output signal 812, and the input discrete envelope tracking signal 806, which will be used to retrain neural network models for the next iteration. Note that the number of training epochs per training cycle should be chosen long enough such that the AI-DPD coefficients completely converge.

The NN-based DPD structure 800 will determine if performance metrics are within predetermined threshold in step 710. For example, the NN-based DPD structure 800 may not continuously be updating AI-DPD coefficients or AI-PA coefficients. Updating these coefficients may occur periodically or when performance metrics (e.g., power efficiency, ACLR, EVM) are not within a predetermined threshold. If the NN-based DPD structure 800 determines that the performance metrics are not within the predetermined threshold, the NN-based DPD structure 800 may operate to generate the AI-DPD coefficients 834 (e.g., by repeating the autoencoder training method 700).

In this embodiment, the NN-based DPD structure 800 is designed using an autoencoder framework. In contrast to the ILA-based system in the first embodiment, the AI-DPD model 840 can be learned directly after learning the forward model of the AI-PA model 820.

Although FIG. 7 illustrates one example autoencoder training method 700 for a neural network model of an NN-based digital pre-distortion architecture, various changes may be made to FIG. 7. For example, while shown as a series of steps, various steps in FIG. 7 could overlap, occur in parallel, occur in a different order, or occur any number of times. For example, the NN-based DPD structure 800 may continuously repeat steps 704 through 710.

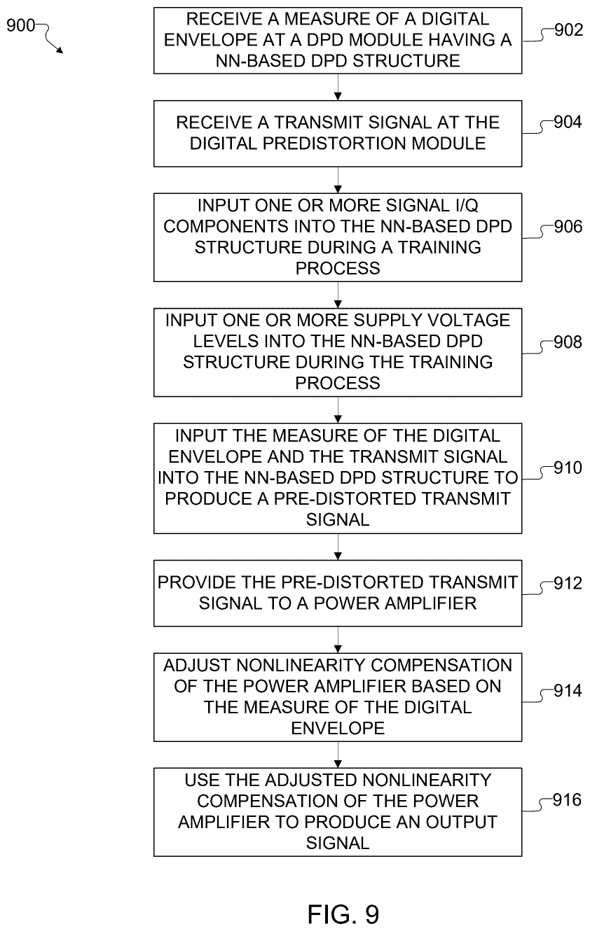

FIG. 9 illustrates an example method of NN-based digital pre-distortion for digital envelope tracking power amplifiers according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of digital pre-distortion could be used without departing from the scope of this disclosure.

The digital pre-distortion module receives a measure of a digital envelope in step 902. For example, the AI-DPD model 502 may receive the input discrete envelope tracking signal 506, e.g., from one or more baseband signals, using one or more transceivers 210 of the gNB 102.

The digital pre-distortion module also receives a transmit signal at the digital pre-distortion module in step 904. For example, the AI-DPD model 502 may receive the input discrete transmit signal 504, e.g., from one or more baseband signals, using one or more transceivers 210 of the gNB 102. The AI-DPD model 502 may receive the input discrete transmit signal 504 and the AI-DPD model 502 concurrently or consecutively.

One or more supply voltage levels are input into the NN-based digital pre-distortion structure during a training process for a neural network architecture of the NN-based digital pre-distortion structure in step 906. For example, the input discrete envelope tracking signal 506 may be input into the ILA-based neural network architecture 550 of the AI-DPD model 502 using the envelope tracking signal input neuron 552.

One or more signal I/Q components are input into the NN-based digital pre-distortion structure during a training process for a neural network architecture of the NN-based digital pre-distortion structure in step 908. For example, the one or more signal I/Q components 554 (e.g., the real transmit signal neuron 556 and the imaginary transmit signal neuron 558) may be input into the ILA-based neural network architecture 550 of the AI-DPD model 502.

The measure of the digital envelope and the transmit signal are input into the NN-based digital pre-distortion structure to produce a pre-distorted transmit signal in step 910. For example, the envelope tracking signal input neuron 552, the real transmit signal neuron 556, and the imaginary transmit signal neuron 558 are processed using the input layer 560, the plurality of hidden layers 562, and the output layer 570 to produce the real pre-distorted output signal 586 and the imaginary pre-distorted output signal 588 of the pre-distorted transmit signal 508.

The pre-distorted transmit signal is then provided to the power amplifier in step 912. For example, the pre-distorted transmit signal 508 is provided to the power amplifier 510, along with the input discrete envelope tracking signal 506 from the DET module 520, to produce the output signal 512.

The nonlinearity compensation of the power amplifier is adjusted based on the measure of the digital envelope in step 914. For example, the output signal 512 and the input discrete envelope tracking signal 506 are input into the AI-DPD training model 530 to produce a training output estimate 532 which is used to generate updated DPD coefficients 534. The updated DPD coefficients 534 are input into the AI-DPD model 502 to adjust the coefficients used by the ILA-based neural network architecture 550, e.g., at the plurality of hidden layers 562, to adjust the non-linearity compensation produced by the AI-DPD model 502 (e.g., at the pre-distorted transmit signal 508) in response to the performance of the power amplifier 510.

The adjusted nonlinearity compensation of the power amplifier is used to produce an output signal in step 916. For example, the AI-DPD model 502 generates a pre-distorted transmit signal 508 based on the updated DPD coefficients 534 and provides the pre-distorted transmit signal 508 to the power amplifier 510. The power amplifier 510 uses the updated pre-distorted transmit signal 508 and the input discrete envelope tracking signal 506 to generate an updated output signal 512. The updated output signal 512 may be used in subsequent iterations by the AI-DPD training model 530 to further update the AI-DPD coefficients used by the AI-DPD model 502.

Although FIG. 9 illustrates one example NN-based digital pre-distortion method 900, various changes may be made to FIG. 9. For example, while shown as a series of steps, various steps in FIG. 9 could overlap, occur in parallel, occur in a different order, or occur any number of times. For example, the NN-based DPD structure 500 may continuously repeat steps 910 through 914.

The present disclosure provides for a neural network (NN)-based digital pre-distortion structure that inputs a measure of a digital envelope as a feature to improve power amplifier nonlinearity compensation for digital envelop tracking.

The above flowcharts illustrate example methods that may be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A computer-implemented method comprising:
receiving a measure of a digital envelope at a digital pre-distortion module having a neural network (NN)-based digital pre-distortion structure for digital envelope tracking (DET);
receiving a transmit signal at the digital pre-distortion module;
inputting the measure of the digital envelope and the transmit signal into the NN-based digital pre-distortion structure to produce a pre-distorted transmit signal;
adjusting nonlinearity compensation of a power amplifier based on the measure of the digital envelope; and
using the adjusted nonlinearity compensation of the power amplifier to produce an output signal.

2. The method of claim 1, further comprising:
inputting one or more supply voltage levels into the NN-based digital pre-distortion structure during a training process for a neural network architecture of the NN-based digital pre-distortion structure.

3. The method of claim 2, wherein the neural network architecture is configured to use dynamic nonlinearity when inputting the one or more supply voltage levels.

4. The method of claim 2, further comprising:
inputting one or more signal I/Q components into the NN-based digital pre-distortion structure during a training process for a neural network architecture of the NN-based digital pre-distortion structure.

5. The method of claim 2, wherein the NN-based digital pre-distortion structure comprises:
an AI-DPD model configured to receive the transmit signal and the measure of the digital envelope to produce the pre-distorted transmit signal; and
an AI-DPD training model coupled to the power amplifier and configured to provide updated DPD coefficients to the AI-DPD model.

6. The method of claim 5, wherein the AI-DPD training model is configured to receive the output signal and the measure of the digital envelope to produce a training output estimate as part of a training process.

7. The method of claim 2, wherein the NN-based digital pre-distortion structure comprises:
an AI-PA training model configured to receive the measure of the digital envelope and the transmit signal to produce AI-PA coefficients for an AI-PA model;
an AI-DPD training model configured to receive the measure of the digital envelope and the transmit signal to produce AI-DPD coefficients using the AI-PA model; and
an AI-DPD model configured to use the AI-DPD coefficients to produce the transmit signal and provide the transmit signal to the power amplifier.

8. An electronic device, comprising:
a power amplifier; and
a processor operably coupled to the power amplifier and configured to cause the electronic device to:
receive a measure of a digital envelope at a digital pre-distortion module having a neural network (NN)-based digital pre-distortion structure for digital envelope tracking (DET);
receive a transmit signal at the digital pre-distortion module;
input the measure of the digital envelope and the transmit signal into the NN-based digital pre-distortion structure to produce a pre-distorted transmit signal;
adjust nonlinearity compensation of the power amplifier based on the measure of the digital envelope; and
use the adjusted nonlinearity compensation of the power amplifier to produce an output signal.

9. The electronic device of claim 8, wherein the processor is further configured to cause the electronic device to:
input one or more supply voltage levels into the NN-based digital pre-distortion structure during a training process for a neural network architecture of the NN-based digital pre-distortion structure.

10. The electronic device of claim 9, wherein the neural network architecture is configured to use dynamic nonlinearity when inputting the one or more supply voltage levels.

11. The electronic device of claim 9, wherein the processor is further configured to cause the electronic device to:
input one or more signal I/Q components into the NN-based digital pre-distortion structure during a training process for a neural network architecture of the NN-based digital pre-distortion structure.

12. The electronic device of claim 9, wherein the NN-based digital pre-distortion structure comprises:
an AI-DPD model configured to receive the transmit signal and the measure of the digital envelope to produce the pre-distorted transmit signal; and
an AI-DPD training model coupled to the power amplifier and configured to provide updated DPD coefficients to the AI-DPD model.

13. The electronic device of claim 12, wherein the AI-DPD training model is configured to receive the output signal and the measure of the digital envelope to produce a training output estimate as part of a training process.

14. The electronic device of claim 9, wherein the NN-based digital pre-distortion structure comprises:
an AI-PA training model configured to receive the measure of the digital envelope and the transmit signal to produce AI-PA coefficients for an AI-PA model;
an AI-DPD training model configured to receive the measure of the digital envelope and the transmit signal to produce AI-DPD coefficients using the AI-PA model; and
an AI-DPD model configured to use the AI-DPD coefficients to produce the transmit signal and provide the transmit signal to the power amplifier.

15. A non-transitory computer-readable medium comprising program code, that when executed by at least one processor of an electronic device, causes the electronic device to:
receive a measure of a digital envelope at a digital pre-distortion module having a neural network (NN)-based digital pre-distortion structure for digital envelope tracking (DET);
receive a transmit signal at the digital pre-distortion module;
input the measure of the digital envelope and the transmit signal into the NN-based digital pre-distortion structure to produce a pre-distorted transmit signal;
adjust nonlinearity compensation of a power amplifier based on the measure of the digital envelope; and
use the adjusted nonlinearity compensation of the power amplifier to produce an output signal.

16. The non-transitory computer-readable medium of claim 15, further comprising program code, that when executed by the at least one processor of an electronic device, causes the electronic device to:
input one or more supply voltage levels into the NN-based digital pre-distortion structure during a training process for a neural network architecture of the NN-based digital pre-distortion structure.

17. The non-transitory computer-readable medium of claim 16, wherein the neural network architecture is configured to use dynamic nonlinearity when inputting the one or more supply voltage levels.

18. The non-transitory computer-readable medium of claim 16, further comprising program code, that when executed by the at least one processor of an electronic device, causes the electronic device to:
input one or more signal I/Q components into the NN-based digital pre-distortion structure during a training process for a neural network architecture of the NN-based digital pre-distortion structure.

19. The non-transitory computer-readable medium of claim 16, wherein the NN-based digital pre-distortion structure comprises:
an AI-DPD model configured to receive the transmit signal and the measure of the digital envelope to produce the pre-distorted transmit signal; and
an AI-DPD training model coupled to the power amplifier and configured to provide updated DPD coefficients to the AI-DPD model.

20. The non-transitory computer-readable medium of claim 16, wherein the NN-based digital pre-distortion structure comprises:
an AI-PA training model configured to receive the measure of the digital envelope and the transmit signal to produce AI-PA coefficients for an AI-PA model;
an AI-DPD training model configured to receive the measure of the digital envelope and the transmit signal to produce AI-DPD coefficients using the AI-PA model; and
an AI-DPD model configured to use the AI-DPD coefficients to produce the transmit signal and provide the transmit signal to the power amplifier.
